(19) United States
(12) Patent Application Publication
(10) Pub. No.: US 2013/0136180 A1
(43) Pub. Date: May 30, 2013

(54) Unified Partitioning Structures and Signaling Methods for High Efficiency Video Coding

(71) Applicant: Futurewei Technologies, Inc., Plano, TX (US)

(72) Inventors: Haitao Yang, Shenzhen (CN); Wen Gao, West Windsor (NJ); Haoping Yu, Carmel, IN (US)

(73) Assignee: FUTUREWEI TECHNOLOGIES, INC., Plano, TX (US)

(21) Appl. No.: 13/689,221

(22) Filed: Nov. 29, 2012

Related U.S. Application Data
(60) Provisional application No. 61/564,685, filed on Nov. 29, 2011.

(51) Int. Cl. H04N 7/50; H04N 7/30

(52) U.S. Cl. CPC H04N 7/5086; H04N 19/00569; H04N 19/00793; H04N 7/30
USPC 375/240.13

(57) ABSTRACT

A method for video coding comprising signaling a prediction mode and a partition mode for a coding unit via a string of bits, wherein one of the bits in the string indicates whether or not the partition size for the coding unit is equivalent to the entire coding unit and another of the bits in the string indicates whether the coding unit partitions are horizontal strips or vertical strips, and wherein, when a slice type of the coding unit is either predictive or bi-predictive, one of the bits in the string indicates whether the prediction type is intra or inter.

### CROSS-REFERENCE TO RELATED APPLICATIONS

The present application claims priority to U.S. Provisional Patent Application No. 61/564,685 filed Nov. 29, 2011 by Haitao Yang et al. and entitled “Unified Partitioning Structures and Signaling Methods for High Efficiency Video Coding”, which is incorporated herein by reference as if reproduced in its entirety.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

The amount of video data needed to depict even a relatively short film can be substantial, which may result in difficulties when the data is to be streamed or otherwise communicated across a communications network with limited bandwidth capacity. Thus, video data is generally compressed before being communicated across modern day telecommunications networks. Video compression devices often use software and/or hardware at the source to code the video data prior to transmission, thereby decreasing the quantity of data needed to represent digital video images. The compressed data is then received at the destination by a video decompression device that decodes the video data. With limited network resources and ever-increasing demands of higher video quality, compression and decompression techniques that improve compression ratio with little to no sacrifice in image quality are desirable.

### SUMMARY

In one embodiment, the disclosure includes a video codec comprising a processor configured to use the same set of coding unit partition modes for both inter coding among blocks from different video pictures and intra coding among blocks within a video picture, wherein the set of partition modes includes at least one non-square partition.

In another embodiment, the disclosure includes a method for video coding comprising signaling a prediction mode and a partition mode for a coding unit via a string of bits, wherein one of the bits in the string indicates whether or not the partition size for the coding unit is equivalent to the entire coding unit and another of the bits in the string indicates whether the coding unit partitions are horizontal strips or vertical strips, and wherein, when a slice type of the coding unit is either predictive or bi-predictive, one of the bits in the string indicates whether the prediction type is intra or inter.

In yet another embodiment, the disclosure includes an apparatus comprising a processor and a transmitter. The processor is configured to encode video using the same set of coding unit partition modes for both inter coding among blocks from different video pictures and intra coding among blocks within a video picture, wherein a size of a transform unit partition is implicitly indicated by a size of a coding unit partition. The transmitter is coupled to the processor and is configured to transmit encoded video to another apparatus.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic diagram of an embodiment of an encoding scheme.

FIG. 2 is a schematic diagram of an embodiment of a decoding scheme.

FIG. 3 is a schematic diagram of a method for video coding.

FIG. 4 is a schematic diagram of a computer system.

### DETAILED DESCRIPTION

It should be understood at the outset that, although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

Video media may involve displaying a sequence of still images or frames in relatively quick succession, thereby causing a viewer to perceive motion. Each frame may comprise a plurality of picture samples or pixels, each of which may represent a single reference point in the frame. During digital processing, each pixel may be assigned an integer value (e.g., 0, 1, . . . , or 255) that represents an image quality or characteristic, such as luminance (luma or Y) or chrominance (chroma including U and V), at the corresponding reference point. In use, an image or video frame may comprise a large numbers of pixels (e.g., 2,073,600 pixels in a 1920×1080 frame), thus it may be cumbersome and inefficient to encode and decode (referred to hereinafter simply as code) each pixel independently. To improve coding efficiency, a video frame is usually broken into a plurality of rectangular blocks or macroblocks, which may serve as basic units of processing such as prediction, transform, and quantization. For example, a typical N×N block may comprise N² pixels, where N is an integer and often a multiple of four.

In working drafts of high efficiency video coding (HEVC), which is issued by the International Telecommunications Union (ITU) Telecommunications Standardization Sector (ITU-T) and the International Organization for Standardization (ISO)/International Electrotechnical Commission (IEC) and poised to be a future video standard, new block concepts have been introduced. For example, coding unit (CU) may refer to a sub-partitioning of a video frame into square blocks of equal or variable size. In HEVC, a CU may replace a macroblock structure of previous standards. Depending on a mode of inter-frame prediction (inter prediction in short) or intra-frame prediction (intra prediction in short), a CU may comprise one or more prediction units (PUs), each of which may serve as a basic unit of prediction. For example, for intra prediction, a 64×64 CU may be symmetrically split into four 32×32 PUs. As another example, for inter prediction, a 64×64 CU may be asymmetrically split into a 16×64 predictive unit (PU) and a 48×64 PU. Similarly, a PU may comprise one or more transform units (TUs), each of which may serve as a basic unit for transform and/or quantization. For example, a 32×32 PU may be symmetrically split into four 16×16 TUs. Multiple TUs of one PU may share a same prediction mode, but may be transformed separately. Herein, the term block may generally refer to any of a macroblock, CU, PU, or TU.

Successive video frames or slices may be substantially correlated, such that a block in a frame does not substantially vary from a corresponding block in a previously coded frame. Inter prediction may exploit temporal redundancies in a sequence of frames, e.g., similarities between corresponding blocks of successive frames, to reduce compression data. In inter prediction, a motion-compensated algorithm may be implemented to calculate a motion vector for a current block in a current frame based on a corresponding block located in one or more reference frames preceding the current frame according to an encoding order.

Similarly, within a video frame, a pixel may be correlated with other pixels within the same frame such that pixel values within a block or across some blocks may vary only slightly and/or exhibit repetitive textures. To exploit spatial correlations between neighboring blocks in the same frame, intra prediction may be implemented by a video encoder/decoder (codec) to interpolate a prediction block (or predicted block) from one or more previously coded neighboring blocks, thereby creating an estimation of the current block. The encoder and decoder may interpolate the prediction block independently, thereby enabling a substantial portion of a frame and/or image to be reconstructed from the communication of a relatively few number of reference blocks, e.g., blocks positioned in (and extending from) the upper-left hand corner of the frame.

To harness these coding efficiencies, video/image coding standards may improve prediction accuracy by utilizing a plurality of prediction modes during intra prediction, each of which may generate a unique texture. After intra prediction, an encoder may compute a difference between the prediction block and the original block (e.g., by subtracting the prediction block from the original block) to produce a residual block. Since an amount of data needed to represent the residual block may typically be less than an amount of data needed to represent the original block, the residual block may be encoded instead of the original block to achieve a higher compression ratio. In existing HEVC software models (HMs), prediction residuals of the residual block in a spatial domain may be converted to transform coefficients of a transform matrix in a frequency domain. The conversion may be realized through a two-dimensional transform, e.g., a transform that closely resembles or is the same as a discrete cosine transform (DCT). In the transform matrix, low-index transform coefficients (e.g., in a top-left section), e.g., corresponding to big spatial features with low spatial frequency components, may have relatively high magnitudes, while high-index transform coefficients (e.g., in a bottom-right section), e.g., corresponding to small spatial features with high spatial frequency components, may have relatively small magnitudes.

An input video comprising a sequence of video frames (or slices) may be received by the encoder. Herein, a frame may refer to any of a predicted frame (P-frame), an intra-coded frame (I-frame), or a bi-predictive frame (B-frame) Likewise, a slice may refer to any of a P-slice, an I-slice, or a B-slice. In an I-slice, all blocks are intra coded. In a P-slice or a B-slice blocks can be intra coded or inter coded. A single reference block is used to make a prediction for a P-slice. For a B-slice, a prediction is made based on two blocks from two possibly different reference frames, and the predictions from the two reference blocks are combined.

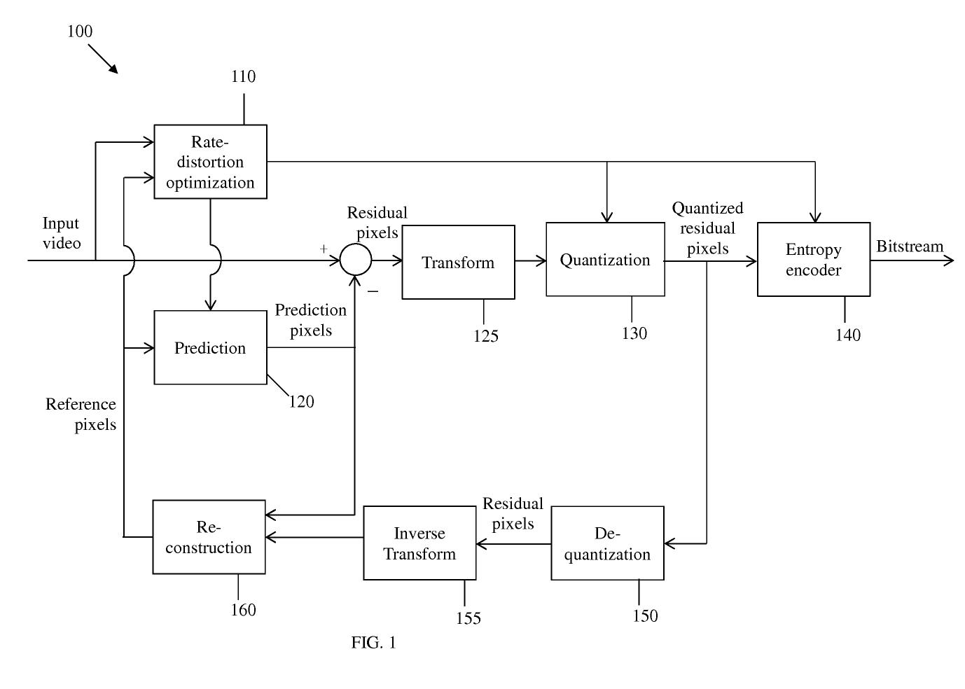

FIG. 1 illustrates an embodiment of an encoding scheme 100, which may be implemented in a video encoder. The encoding scheme 100 may comprise a RDO module 110, a prediction module 120, a transform module 125, a quantization module 130, an entropy encoder 140, a de-quantization module 150, an inverse transform module 155, and a reconstruction module 160.

The encoding scheme 100 may be implemented in a video encoder, which may receive an input video comprising a sequence of video frames. The RDO module 110 may be configured to control one or more of other modules. Based on logic decisions made by the RDO module 110, the prediction module 120 may utilize reference pixels to generate prediction pixels for a current block. Each prediction pixel may be subtracted from a corresponding original pixel in the current block, thereby generating a residual pixel. After all residual pixels have been computed to obtain a residual block, the residual block may go through the transform module 125 and then the quantization module 130. Scales of the residual values may be altered, e.g., each residual value may be divided by a factor of five. As a result, some non-zero residual values may be converted into zero residual values (e.g., values less than a certain threshold may be deemed as zero).

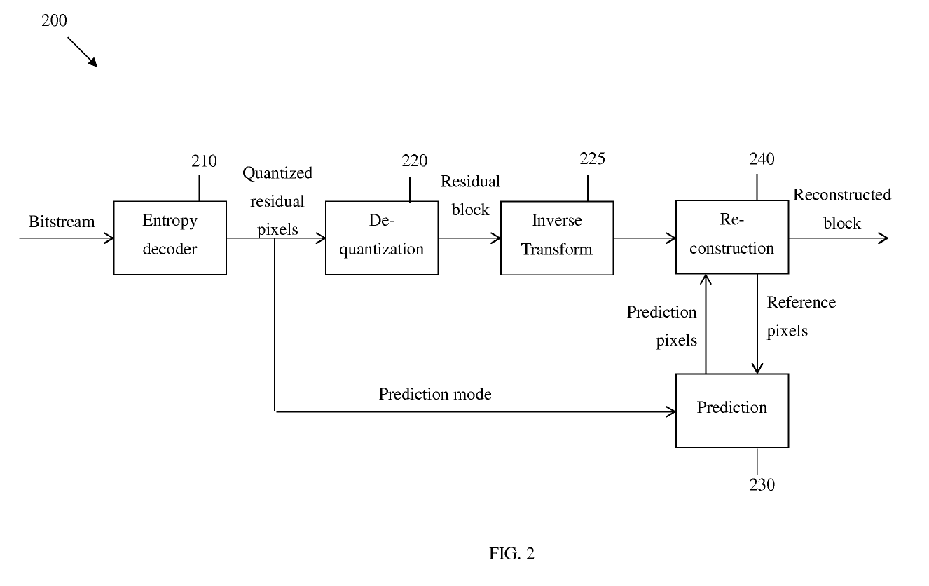

FIG. 2 illustrates an embodiment of a decoding scheme 200, which may be implemented in a video decoder. The decoding scheme 200 may correspond to the encoding scheme 100, and may comprise an entropy decoder 210, a de-quantization module 220, an inverse transform module 225, a prediction module 230, and a reconstruction module 240 arranged as shown in FIG. 2. In operation, an encoded bitstream containing information of a sequence of video frames may be received by the entropy decoder 210, which may decode the bitstream to an uncompressed format. Non-zero quantized encoded residual values may be decoded by the entropy decoder 210.

For a current block being decoded, a residual block may be generated after the execution of the entropy decoder 210. To properly place each non-zero quantized residual pixel into the residual block, a full significant map decoded by the entropy decoder 210 may be used. Then, quantized residual values may be fed into the de-quantization module 220, which may recover a scale of the residual values (e.g., multiply each residual value by a factor of 5). The quantized residual values may then be fed into the inverse transform module 225. Note that after quantization and de-quantization, residual values may not completely recover to their original values, and thus some information loss may occur in the coding process.

In addition, information containing a prediction mode may also be decoded by the entropy decoder 210. Based on the prediction mode, the prediction module 230 may generate a prediction block. If the decoded prediction mode is an inter mode, one or more previously decoded reference frames may be used to generate the prediction block. If the decoded prediction mode is an intra-mode, a plurality of previously decoded reference pixels may be used to generate the prediction block. Then, the reconstruction module 240 may combine the residual block with the prediction block to generate a reconstructed block. Additionally, to facilitate continuous decoding of video frames, the reconstructed block may be used in a reference frame to inter predict future frames. Some pixels of the reconstructed block may also serve as reference pixels for intra prediction of future blocks in the same frame.

As mentioned above, the basic coding unit in the HEVC model (HM) is the CU, which is similar to a macroblock in the H.264/AVC (Advanced Video Coding) standard. However, unlike a macroblock, the size of a CU is variable, and a CU can have different prediction types: intra type or inter type. The PU is the basic unit for signaling the prediction mode to the decoder. One CU can have one PU or multiple PUs. The TU is the basic unit for transform. One CU can have one or multiple TUs. Currently in the HEVC Working Draft (WD), the supported PU partitions in intra coded CU are PART_{—}2N×2N and PART_N×N. The supported PU partitions in inter coded CU are PART_{—}2N×2N, PART_{—}2N×N, PART_N×2N, PART_N×N, PART_{—}2N×nU, PART_{—}2N×nD, PART_nL×2N, PART_nR×2N.

It may be observed that the available partition modes are different for intra and for inter. In particular, intra coding uses only square partitions, while inter coding can use either square or non-square partitions. Due to the differences in the partition modes used for intra coding or inter coding, different signaling methods may currently be used for intra coded CUs and inter coded CUs.

In the embodiments disclosed herein, a unified partitioning structure is provided. That is, the same set of partition modes is used for intra coding and for inter coding, which results in a unified partitioning structure. In particular, the embodiments provide non-square partitions for intra coded CUs. The entropy coding for a partition mode is modified accordingly and is described herein. In addition, the embodiments provide a consistent method of signaling prediction and partition information for both intra coded CUs and inter coded CUs. In the disclosed schemes, the TU partition mode is derived from the prediction type and the PU partition mode, so encoders do not need to signal the TU partition mode explicitly to the decoder. The prediction operations for each PU and the transform and entropy coding operations for each TU can be done using the existing methods in HM.

Three aspects related to the unified partitioning structure will now be described in turn: a unified set of partition modes for intra and inter coding, methods of signaling the prediction type and partition mode, and an implicit TU partition mode.

Partition mode (denoted as Part Mode hereinafter) specifies the PU partitions inside a CU. In the partitioning structure disclosed herein, the same set of Part Mode is used in both intra and inter coding. In an embodiment, a set of Part Mode may be {PART_{—}2N×2N, PART_{—}2N×N, PART_N×2N, PART_N×N, PART_{—}2N×nU, PART_{—}2N×nD, PART_mL×2N, PART_nR×2N}. For this set of Part Mode, the size (WIDTH×HEIGHT) is specified in Table 1, which denotes the size of a rectangular block. The size of a CU is 2N×2N. The exact value of N can be 4, 8, 16, or 32 in the current HEVC design, and can be further extended to 64 or larger. This notation of size is used to describe the relative size and shape of one or multiple PU partitions within a CU.

TABLE 1

| | Number | Size of each partition | | | |
|---|---|---|---|---|---|
| | of par- | | | Parti- | Parti- |
| PartMode | titions | Partition 1 | Partition 2 | tion 3 | tion 4 |
| PART_2Nx2N | 1 | 2N × 2N | — | — | — |
| PART_2NxN | 2 | 2N × N | 2N × N | — | — |
| PART_Nx2N | 2 | N × 2N | N × 2N | — | — |
| PART_NxN | 4 | N × N | N × N | N × N | N × N |
| PART_2NxnU | 2 | 2N × (N/2) | 2N × (3N/2) | — | — |
| PART_2NxnD | 2 | 2N × (3N/2) | 2N × (N/2) | — | — |
| PART_nLx2N | 2 | (N/2) × 2N | (3N/2) × 2N | — | — |
| PART_nRx2N | 2 | (3N/2) × 2N | (N/2) × 2N | — | — |

In another embodiment, the set of Part Mode may be {PART_{—}2N×2N, PART_{—}2N×N, PART_N×2N, PART_N×N}. For this set of Part Mode, the size (WIDTH×HEIGHT) is specified in Table 2.

TABLE 2

| | Number | | | | |
|---|---|---|---|---|---|
| | of par- | Size of each partition | | | |
| PartMode | titions | Partition 1 | Partition 2 | Partition 3 | Partition 4 |
| PART_2Nx2N | 1 | 2N × 2N | — | — | — |
| PART_2NxN | 2 | 2N × N | 2N × N | — | — |
| PART_Nx2N | 2 | N × 2N | N × 2N | — | — |
| PART_NxN | 4 | N × N | N × N | N × N | N × N |

In another embodiment, the set of Part Mode may be {PART_{—}2N×2N, PART_{—}2N×N, PART_N×2N, PART_{—}2N×hN, PART_hN×2N, PART_N×N}. For this set of Part Mode, the size (WIDTH×HEIGHT) is specified in Table 3.

TABLE 3

| | | Size of each partition | | | |
|---|---|---|---|---|---|
| | Number of | | Parti- | Parti- | Parti- |
| PartMode | partitions | Partition 1 | tion 2 | tion 3 | tion 4 |
| PART_2Nx2N | 1 | 2N × 2N | — | — | — |
| PART_2NxN | 2 | 2N × N | 2N × N | — | — |
| PART_Nx2N | 2 | N × 2N | N × 2N | — | — |
| PART_NxN | 4 | N × N | N × N | N × N | N × N |
| PART_2NxhN | 4 | 2N × (N/2) | 2N × | 2N × | 2N × |
| | | | (N/2) | (N/2) | (N/2) |
| PART_hNx2N | 4 | (N/2) × 2N | (N/2) × | (N/2) × | (N/2) × |
| | | | 2N | 2N | 2N |

It may be noted that PART_N×N is only used for a CU with a minimal size.

Methods of signaling the prediction mode and partition mode will now be considered. Prediction mode (denoted as PredMode hereinafter) specifies whether a CU is intra coded or inter coded. Prediction mode and partition mode may be jointly coded. Using CABAC, a binary codeword or a bin string is assigned to each combination of the prediction mode and the partition mode. The encoder encodes the bin string of the selected combination of prediction mode and partition mode and writes the encoded bin string into a bit stream. A bit stream with the encoded prediction mode and partition mode information for each CU is then sent to the decoder. The decoder may accordingly derive the prediction mode and the partition mode from the decoded bin string.

For the partition modes listed in Table 1, an example of signaling methods of prediction modes and partition modes is shown in Table 4. In Table 4, cLog2 CUSize is a variable specifying the size of the current CU. For example, if the size of a CU is 8×8, then cLog2CUSize=log 2(8)=3. Although all intra partition modes specified in Table 1 are used for both intra and inter prediction type as shown in Table 4, it is possible that only a part of the set is available in some cases. Here, a case denotes a specific combination of slice type, prediction type, and cLog2CUSize value. As mentioned above, slice type may be Intra (I), Predictive (P), or Bi-predictive (B), and prediction mode may be intra or inter. cLog2CUSize is a variable indicating the size of the current CU. For example, PART_N×N is not available when cLog2CUSize>3, as shown in Table 4. As another example, when cLog2CUSize=3, only PART_{—}2N×2N, PART_{—}2N×N, PART_N×2N, PART_N×N are available, as shown in Table 4. For another example, when cLog2CUSize>3 and the slice type is P or B, only PART_{—}2N×2N, PART_{—}2N×N, PART_N×2N are available, as shown in Table 4.

I, P and B denote different slice types. All CUs in I slices are intra coded. CUs in P or B slices may be either intra coded or inter coded. Or equivalently, the prediction type of a CU in I slices may only be intra, while the prediction type of a CU in P or B slices may be either intra or inter. In the case of P or B slices, the first bin of the bin string is used to indicate whether the prediction type is intra or inter. In the case of I slice, since all blocks can only be intra coded, there may be no need to use a bin to signal the prediction type.

In some cases (e.g., for a particular combination of slice type and cLog2CUSize), at least a portion of the bin string representing the same partition mode may be the same. For example, a portion of the bin string for PART_N×2N is 001 in two cases. In the case where slice type is I, PredMode is intra, and cLog2CUSize>3, the bin string is 001. In the case where slice type is P or B, PredMode is inter, and cLog2CUSize>3, the bin string is 0 001. The difference between the two cases is that the initial “0” in the second case indicates that the PredMode is inter. This initial “0” is not needed in the first case since it is already known that the PredMode is intra.

It should be noted that there are also other binarization methods to obtain a different bin string design for the representation of all the cases in Table 4, such as Exp-Golomb code binarization, truncated unary code binarization, fixed length code binarization, etc. The bin string may also be obtained by concatenating more than one codeword. For example, two fixed length codes may be concatenated to get a bin string, as a binarization method.

It should also be noted that a bin in a bin string is usually used to signal two events. For example, when the slice type is P or B, the first bin is used to signal whether the prediction type is intra or inter prediction. In another example, when the slice type is P or B and cLog2CUSize>3, the second bin is used to signal whether the partition mode is 2N×2N or some other partition mode, the third bin (if applicable) is used to signal whether the PU partitions are horizontal strips (rectangular with width larger than height) or vertical strips (rectangular with width smaller than height), the fourth bin is used to signal whether the two partitioned PUs are of the same size or different sizes, and the fifth bit is used to signal the position of the smaller PU if the CU is partitioned into two PUs of different sizes. In all the cases listed above, a bin value equal to 0 may be chosen to signal either of the two events, and a bin value equal to 1 may be chosen to signal the other event. In addition, the position of a bin may also be changed. For example, the third bin may be placed into the fourth position and the fourth bin may be placed into the third position. An example of the bin values used in this design is provided in Table 4.

Since some overhead may be involved in transmitting such bin strings, it may be beneficial to transmit shorter bin strings more frequently than longer bin strings. Thus, in an embodiment, bin strings with a relatively shorter length are used for partition and prediction modes that are expected to be used more frequently.

TABLE 4

| | | | Bin string | |
|---|---|---|---|---|
| Slice type | PredMode | PartMode | cLog2CUSize > 3 | cLog2CUSize = 3 |
| I | MODE_INTRA | PART_2Nx2N | 1 | 1 |
| | MODE_INTRA | PART_2NxN | 011 | 001 |
| | MODE_INTRA | PART_Nx2N | 001 | 000 |
| | MODE_INTRA | PART_2NxnU | 0100 | — |
| | MODE_INTRA | PART_2NxnD | 0101 | — |
| | MODE_INTRA | PART_nLx2N | 0000 | — |
| | MODE_INTRA | PART_nRx2N | 0001 | — |
| | MODE_INTRA | PART_NxN | — | 01 |
| P/B | MODE_INTER | PART_2Nx2N | 0 1 | 0 1 |
| | MODE_INTER | PART_2NxN | 0 011 | 0 001 |
| | MODE_INTER | PART_Nx2N | 0 001 | 0 000 |
| | MODE_INTER | PART_2NxnU | 0 0100 | — |
| | MODE_INTER | PART_2NxnD | 0 0101 | — |
| | MODE_INTER | PART_nLx2N | 0 0000 | — |
| | MODE_INTER | PART_nRx2N | 0 0001 | — |
| | MODE_INTER | PART_NxN | — | 0 01 |
| | MODE_INTRA | PART_2Nx2N | 1 1 | 1 1 |
| | MODE_INTRA | PART_2NxN | 1 01 | 1 001 |
| | MODE_INTRA | PART_Nx2N | 1 00 | 1 000 |
| | MODE_INTRA | PART_2NxnU | — | — |
| | MODE_INTRA | PART_2NxnD | — | — |
| | MODE_INTRA | PART_nLx2N | — | — |
| | MODE_INTRA | PART_nRx2N | — | — |
| | MODE_INTRA | PART_NxN | — | 1 01 |

As mentioned above, there is freedom to specify whether the whole set or a part of the set is available for some cases. For example, in Table 4, in the case where the slice type is equal to P or B, the PredMode is intra, and cLog2CUSize>3, only three partition modes, PART_{—}2N×2N, PART_{—}2N×N, and PART_N×2N, are available. Another example is provided in Table 5, in which the whole set of partition modes except PART_N×N is available.

TABLE 5

| | | | Bin string | |
|---|---|---|---|---|
| Slice type | PredMode | PartMode | cLog2CUSize > 3 | cLog2CUSize = 3 |
| I | MODE_INTRA | PART_2Nx2N | 1 | 1 |
| | MODE_INTRA | PART_2NxN | 011 | 001 |
| | MODE_INTRA | PART_Nx2N | 001 | 000 |
| | MODE_INTRA | PART_2NxnU | 0100 | — |
| | MODE_INTRA | PART_2NxnD | 0101 | — |
| | MODE_INTRA | PART_nLx2N | 0000 | — |
| | MODE_INTRA | PART_nRx2N | 0001 | — |
| | MODE_INTRA | PART_NxN | — | 01 |
| P/B | MODE_INTER | PART_2Nx2N | 0 1 | 0 1 |
| | MODE_INTER | PART_2NxN | 0 011 | 0 001 |
| | MODE_INTER | PART_Nx2N | 0 001 | 0 000 |
| | MODE_INTER | PART_2NxnU | 0 0100 | — |
| | MODE_INTER | PART_2NxnD | 0 0101 | — |
| | MODE_INTER | PART_nLx2N | 0 0000 | — |
| | MODE_INTER | PART_nRx2N | 0 0001 | — |
| | MODE_INTER | PART_NxN | — | 0 01 |
| | MODE_INTRA | PART_2Nx2N | 1 1 | 1 1 |
| | MODE_INTRA | PART_2NxN | 1 011 | 1 001 |
| | MODE_INTRA | PART_Nx2N | 1 001 | 1 000 |
| | MODE_INTRA | PART_2NxnU | 1 0100 | — |
| | MODE_INTRA | PART_2NxnD | 1 0101 | — |
| | MODE_INTRA | PART_nLx2N | 1 0000 | — |
| | MODE_INTRA | PART_nRx2N | 1 0001 | — |
| | MODE_INTRA | PART_NxN | — | 1 01 |

In Table 5, when the slice type is equal to P or B, the PredMode is intra, and cLog2CUSize=3, only four partition modes, PART_{—}2N×2N, PART_{—}2N×N, PART_N×2N, and PART_N×N, are available. In another embodiment, the whole set of partition modes is available.

Choosing the partition modes listed in Table 2, another example of signaling methods of prediction types and partition modes is shown in Table 6.

TABLE 6

| | | | Bin string | |
|---|---|---|---|---|
| Slice type | PredMode | PartMode | cLog2CUSize > 3 | cLog2CUSize = 3 |
| I | MODE_INTRA | PART_2Nx2N | 1 | 1 |
| | MODE_INTRA | PART_2NxN | 01 | 001 |
| | MODE_INTRA | PART_Nx2N | 00 | 000 |
| | MODE_INTRA | PART_NxN | — | 01 |
| P/B | MODE_INTER | PART_2Nx2N | 0 1 | 0 1 |
| | MODE_INTER | PART_2NxN | 0 01 | 0 001 |
| | MODE_INTER | PART_Nx2N | 0 00 | 0 000 |
| | MODE_INTER | PART_NxN | — | 0 01 |
| | MODE_INTRA | PART_2Nx2N | 1 1 | 1 1 |
| | MODE_INTRA | PART_2NxN | 1 01 | 1 001 |
| | MODE_INTRA | PART_Nx2N | 1 00 | 1 000 |
| | MODE_INTRA | PART_NxN | — | 1 01 |

Choosing the partition mode listed in Table 3, another example of signaling methods of prediction types and partition modes is shown in Table 7.

TABLE 7

| | | | Bin string | |
|---|---|---|---|---|
| Slice type | PredMode | PartMode | cLog2CUSize > 3 | cLog2CUSize = 3 |
| I | MODE_INTRA | PART_2Nx2N | 1 | 1 |
| | MODE_INTRA | PART_2NxN | 011 | 0011 |
| | MODE_INTRA | PART_Nx2N | 001 | 0001 |
| | MODE_INTRA | PART_2NxhN | 010 | 0010 |
| | MODE_INTRA | PART_hNx2N | 000 | 0000 |
| | MODE_INTRA | PART_NxN | — | 01 |
| P/B | MODE_INTER | PART_2Nx2N | 0 1 | 0 1 |
| | MODE_INTER | PART_2NxN | 0 011 | 0 0011 |
| | MODE_INTER | PART_Nx2N | 0 001 | 0 0001 |
| | MODE_INTER | PART_2NxhN | 0 010 | 0 0010 |
| | MODE_INTER | PART_hNx2N | 0 000 | 0 0000 |
| | MODE_INTER | PART_NxN | — | 0 01 |
| | MODE_INTRA | PART_2Nx2N | 1 1 | 1 1 |
| | MODE_INTRA | PART_2NxN | 1 011 | 1 0011 |
| | MODE_INTRA | PART_Nx2N | 1 001 | 1 0001 |
| | MODE_INTRA | PART_2NxhN | 1 010 | 1 0010 |
| | MODE_INTRA | PART_hNx2N | 1 000 | 1 0000 |
| | MODE_INTRA | PART_NxN | — | 1 01 |

In Table 7, in the case where the slice type is equal to P or B, the PredMode is intra, and cLog2CUSize=3, the whole set of partition modes is available. In another embodiment, only four partition modes, PART_{—}2N×2N, PART_{—}2N×N, PART_N×2N, and PART_N×N, are available. Under this condition, the same set of bin strings as in Table 6 may be used for the four available partition modes.

An implicit TU partition mode will now be considered. For intra coded CU and inter coded CU, the same mechanism may be used to derive the TU partition mode when the TU depth equals 1. A TU depth equal to 1 means that the current CU is split into four TU partitions. The TU partition may be derived using the methods described below.

Choosing the partition mode listed in Table 1, an example of an implicit TU partition mode for TU depth equals 1 is shown in Table 8. TUs obtained after partition are of the same size.

TABLE 8

| | | Size of each TU partition | | | |
|---|---|---|---|---|---|
| | Number of | | Parti- | Parti- | Parti- |
| PartMode | TU partitions | Partition 1 | tion 2 | tion 3 | tion 4 |
| PART_2Nx2N | 4 | N × N | N × N | N × N | N × N |
| PART_2NxN | 4 | 2N × (N/2) | 2N × | 2N × | 2N × |
| | | | (N/2) | (N/2) | (N/2) |
| PART_Nx2N | 4 | (N/2) × 2N | (N/2) × | (N/2) × | (N/2) × |
| | | | 2N | 2N | 2N |
| PART_2NxnU | 4 | 2N × (N/2) | 2N × | 2N × | 2N × |
| | | | (N/2) | (N/2) | (N/2) |
| PART_2NxnD | 4 | 2N × (N/2) | 2N × | 2N × | 2N × |
| | | | (N/2) | (N/2) | (N/2) |
| PART_nLx2N | 4 | (N/2) × 2N | (N/2) × | (N/2) × | (N/2) × |
| | | | 2N | 2N | 2N |
| PART_nRx2N | 4 | (N/2) × 2N | (N/2) × | (N/2) × | (N/2) × |
| | | | 2N | 2N | 2N |

Choosing the partition mode listed in Table 2, an example of an implicit TU partition mode is shown in Table 9.

TABLE 9

| | | Size of each TU partition | | | |
|---|---|---|---|---|---|
| | Number of | | Parti- | Parti- | Parti- |
| PartMode | TU partitions | Partition 1 | tion 2 | tion 3 | tion 4 |
| PART_2Nx2N | 4 | N × N | N × N | N × N | N × N |
| PART_2NxN | 4 | 2N × (N/2) | 2N × | 2N × | 2N × |
| | | | (N/2) | (N/2) | (N/2) |
| PART_Nx2N | 4 | (N/2) × 2N | (N/2) × | (N/2) × | (N/2) × |
| | | | 2N | 2N | 2N |

Choosing the partition mode listed in Table 3, an example of an implicit TU partition mode is shown in Table 10.

TABLE 10

| | Number of | Size of each TU partition | | | |
|---|---|---|---|---|---|
| | TU | | | Parti- | Parti- |
| PartMode | partitions | Partition 1 | Partition 2 | tion 3 | tion 4 |
| PART_2Nx2N | 4 | N × N | N × N | N × N | N × N |
| PART_2NxN | 4 | 2N × (N/2) | 2N × | 2N × | 2N × |
| | | | (N/2) | (N/2) | (N/2) |
| PART_Nx2N | 4 | (N/2) × 2N | (N/2) × | (N/2) × | (N/2) × |
| | | | 2N | 2N | 2N |
| PART_2NxhN | 4 | 2N × (N/2) | 2N × | 2N × | 2N × |
| | | | (N/2) | (N/2) | (N/2) |
| PART_hNx2N | 4 | (N/2) × 2N | (N/2) × | (N/2) × | (N/2) × |
| | | | 2N | 2N | 2N |

It may be noted that when the PU partition mode is PART_N×N, the CU is by default evenly divided into four smaller square blocks, i.e., four N×N TU partitions. So the derivation of the TU partition mode when the PU partition mode is PART_N×N is not listed in the above three tables.

It can be seen that the size of a TU partition is implicitly indicated by the size of a CU partition, as indicated by the partition mode. Thus, no further signaling is needed to inform the decoder of how the TUs are to be partitioned.

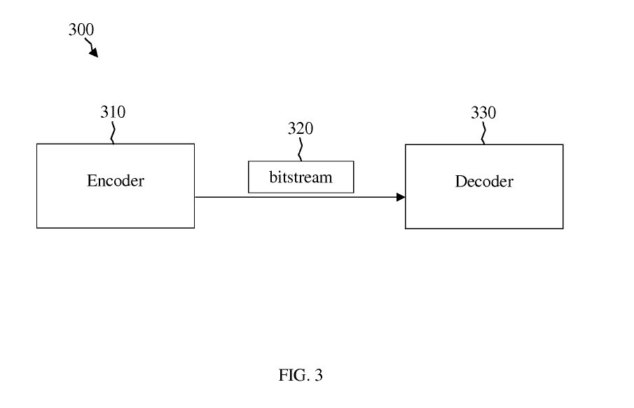

FIG. 3 illustrates a method 300 for video coding. An encoder 310 transmits a bitstream 320 to a decoder 330. It should be understood that the encoder 310 and the decoder 330 may be components within video encoding and decoding systems such as those described above and may be coupled to the appropriate processing, transmitting, and receiving components. The bitstream 320 includes a binary string that encodes a prediction mode and a partition mode for a coding unit of video data. The same set of coding unit partition modes is used for both inter coding of the video data and intra coding of the video data.

The embodiments disclosed herein may reduce implementation costs and/or complexity associated with video encoding and decoding by using the same set of prediction partitions for intra and inter coding, by signaling prediction mode and prediction partition information in a consistent manner, and by using a consistent set of rules to infer transform partition information from prediction partition information.

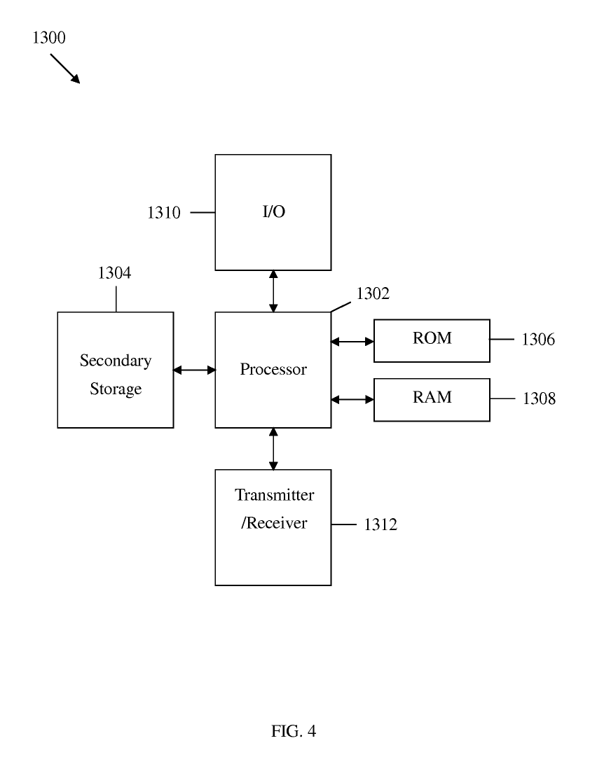

The schemes described above may be implemented on a network component, such as a computer or network component with sufficient processing power, memory resources, and network throughput capability to handle the necessary workload placed upon it. FIG. 4 illustrates an embodiment of a network component or computer system 1300 suitable for implementing one or more embodiments of the methods disclosed herein, such as the encoding scheme 100, the decoding scheme 200, and the encoding method 300. The network component or computer system 1300 includes a processor 1302 that is in communication with memory devices including secondary storage 1304, read only memory (ROM) 1306, random access memory (RAM) 1308, input/output (I/O) devices 1310, and transmitter/receiver 1312. Although illustrated as a single processor, the processor 1302 is not so limited and may comprise multiple processors. The processor 1302 may be implemented as one or more general purpose central processor unit (CPU) chips, cores (e.g., a multi-core processor), field-programmable gate arrays (FPGAs), application specific integrated circuits (ASICs), and/or digital signal processors (DSPs), and/or may be part of one or more ASICs. The processor 1302 may be configured to implement any of the schemes described herein, including the encoding scheme 100, the decoding scheme 200, and the encoding method 300. The processor 1302 may be implemented using hardware or a combination of hardware and software.

The secondary storage 1304 is typically comprised of one or more disk drives or tape drives and is used for non-volatile storage of data and as an over-flow data storage device if the RAM 1308 is not large enough to hold all working data. The secondary storage 1304 may be used to store programs that are loaded into the RAM 1308 when such programs are selected for execution. The ROM 1306 is used to store instructions and perhaps data that are read during program execution. The ROM 1306 is a non-volatile memory device that typically has a small memory capacity relative to the larger memory capacity of the secondary storage 1304. The RAM 1308 is used to store volatile data and perhaps to store instructions. Access to both the ROM 1306 and the RAM 1308 is typically faster than to the secondary storage 1304.

The transmitter/receiver 1312 may serve as an output and/or input device of the computer system 1300. For example, if the transmitter/receiver 1312 is acting as a transmitter, it may transmit data out of the computer system 1300. If the transmitter/receiver 1312 is acting as a receiver, it may receive data into the computer system 1300. The transmitter/receiver 1312 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards such as code division multiple access (CDMA), global system for mobile communications (GSM), long-term evolution (LTE), worldwide interoperability for microwave access (WiMAX), and/or other air interface protocol radio transceiver cards, and other well-known network devices. The transmitter/receiver 1312 may enable the processor 1302 to communicate with an Internet or one or more intranets. I/O devices 1310 may include a video monitor, liquid crystal display (LCD), touch screen display, or other type of video display for displaying video, and may also include a video recording device for capturing video. I/O devices 1310 may also include one or more keyboards, mice, or track balls, or other well-known input devices.

It is understood that by programming and/or loading executable instructions onto the computer system 1300, at least one of the processor 1302, the secondary storage 1304, the RAM 1308, and the ROM 1306 are changed, transforming the computer system 1300 in part into a particular machine or apparatus (e.g., a video codec having the novel functionality taught by the present disclosure). The executable instructions may be stored on the secondary storage 1304, the ROM 1306, and/or the RAM 1308 and loaded into the processor 1302 for execution. It is fundamental to the electrical engineering and software engineering arts that functionality that can be implemented by loading executable software into a computer can be converted to a hardware implementation by well-known design rules. Decisions between implementing a concept in software versus hardware typically hinge on considerations of stability of the design and numbers of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable that will be produced in large volume may be preferred to be implemented in hardware, for example in an ASIC, because for large production runs the hardware implementation may be less expensive than the software implementation. Often a design may be developed and tested in a software form and later transformed, by well-known design rules, to an equivalent hardware implementation in an application specific integrated circuit that hardwires the instructions of the software. In the same manner as a machine controlled by a new ASIC is a particular machine or apparatus, likewise a computer that has been programmed and/or loaded with executable instructions may be viewed as a particular machine or apparatus.

At least one embodiment is disclosed and variations, combinations, and/or modifications of the embodiment(s) and/or features of the embodiment(s) made by a person having ordinary skill in the art are within the scope of the disclosure. Alternative embodiments that result from combining, integrating, and/or omitting features of the embodiment(s) are also within the scope of the disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, Rl, and an upper limit, Ru, is disclosed, any number falling within the range is specifically disclosed. In particular, the following numbers within the range are specifically disclosed: R=Rl+k*(Ru−Rl), wherein k is a variable ranging from 1 percent to 100 percent with a 1 percent increment, i.e., k is 1 percent, 2 percent, 3 percent, 4 percent, 5 percent, . . . , 70 percent, 71 percent, 72 percent, . . . , 95 percent, 96 percent, 97 percent, 98 percent, 99 percent, or 100 percent. Moreover, any numerical range defined by two R numbers as defined in the above is also specifically disclosed. The use of the term about means±10% of the subsequent number, unless otherwise stated. Use of the term “optionally” with respect to any element of a claim means that the element is required, or alternatively, the element is not required, both alternatives being within the scope of the claim. Use of broader terms such as comprises, includes, and having should be understood to provide support for narrower terms such as consisting of, consisting essentially of, and comprised substantially of. Accordingly, the scope of protection is not limited by the description set out above but is defined by the claims that follow, that scope including all equivalents of the subject matter of the claims. Each and every claim is incorporated as further disclosure into the specification and the claims are embodiment(s) of the present disclosure. The discussion of a reference in the disclosure is not an admission that it is prior art, especially any reference that has a publication date after the priority date of this application. The disclosure of all patents, patent applications, and publications cited in the disclosure are hereby incorporated by reference, to the extent that they provide exemplary, procedural, or other details supplementary to the disclosure.

While several embodiments have been provided in the present disclosure, it may be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and may be made without departing from the spirit and scope disclosed herein.

What is claimed is:

1. A video codec comprising:
a processor configured to use the same set of coding unit partition modes for both inter coding among blocks from different video pictures and intra coding among blocks within a video picture, wherein the set of partition modes includes at least one non-square partition.

2. The video codec of claim 1, wherein the set of partition modes includes: a first partition mode consisting of one partition with a size of 2N×2N; a second partition mode consisting of two partitions each with a size of 2N×N; a third partition mode consisting of two partitions each with a size of N×2N; a fourth partition mode consisting of four partitions each with a size of N×N; a fifth partition mode consisting of two partitions, the first partition having a size of 2N×(N/2) and the second partition having a size of 2N×(3N/2); a sixth partition mode consisting of two partitions, the first partition having a size of 2N×(3N/2) and the second partition having a size of 2N×(N/2); a seventh partition mode consisting of two partitions, the first partition having a size of (N/2)×2N and the second partition having a size of (3N/2)×2N; and an eighth partition mode consisting of two partitions, the first partition having a size of (3N/2)×2N and the second partition having a size of (N/2)×2N, and wherein a size of 2N×2N is equivalent to an entire coding unit, with the portion of the size before the ‘×’ symbol indicating the width of a partition and the portion of the size after the ‘×’ symbol indicating the height of a partition.

3. The video codec of claim 1, wherein the set of partition modes includes: a first partition mode consisting of one partition with a size of 2N×2N, a second partition mode consisting of two partitions each with a size of 2N×N, a third partition mode consisting of two partitions each with a size of N×2N, and a fourth partition mode consisting of four partitions each with a size of N×N, and wherein a size of 2N×2N is equivalent to an entire coding unit, with the portion of the size before the ‘×’ symbol indicating the width of a partition and the portion of the size after the ‘×’ symbol indicating the height of a partition.

4. The video codec of claim 1, wherein the set of partition modes includes: a first partition mode consisting of one partition with a size of 2N×2N, a second partition mode consisting of two partitions each with a size of 2N×N, a third partition mode consisting of two partitions each with a size of N×2N, a fourth partition mode consisting of four partitions each with a size of N×N, a fifth partition mode consisting of four partitions each with a size of 2N×(N/2), and a sixth partition mode consisting of four partitions each with a size of (N/2)×2N, and wherein a size of 2N×2N is equivalent to an entire coding unit, with the portion of the size before the ‘×’ symbol indicating the width of a partition and the portion of the size after the ‘×’ symbol indicating the height of a partition.

5. The video codec of claim 1, wherein a prediction mode and a partition mode for a coding unit are signaled via a string of bits, and wherein one of the bits in the string indicates whether or not the partition size for the coding unit is equivalent to the entire coding unit and another of the bits in the string indicates whether the coding unit partitions are horizontal strips or vertical strips, and wherein, when a slice type of the coding unit is either predictive or bi-predictive, one of the bits in the string indicates whether the prediction type is intra or inter.

6. The video codec of claim 5, wherein another of the bits in the string indicates, when the coding unit is partitioned into two partitions, whether or not the two partitions have the same size, another of the bits in the string indicates the position of a smaller partition if the coding unit is partitioned into two partitions of different sizes, and another of the bits in the string indicates, when the coding unit partitions are horizontal strips or vertical strips, whether or not the number of the partitions of the same size is two or four.

7. The video codec of claim 1, wherein a size of a transform unit partition is implicitly indicated by a size of a coding unit partition.

8. A method for video coding comprising:
signaling a prediction mode and a partition mode for a coding unit via a string of bits, wherein one of the bits in the string indicates whether or not the partition size for the coding unit is equivalent to the entire coding unit and another of the bits in the string indicates whether the coding unit partitions are horizontal strips or vertical strips, and wherein, when a slice type of the coding unit is either predictive or bi-predictive, one of the bits in the string indicates whether the prediction type is intra or inter.

9. The method of claim 8, wherein another of the bits in the string indicates, when the coding unit is partitioned into two partitions, whether or not the two partitions have the same size, another of the bits in the string indicates the position of a smaller partition if the coding unit is partitioned into two partitions of different sizes, and another of the bits in the string indicates, when the coding unit partitions are horizontal strips or vertical strips, whether or not the number of the partitions of the same size is two or four.

10. The method of claim 8, further comprising using the same set of coding unit partition modes for both inter coding among blocks from different video pictures and intra coding among blocks within a video picture, wherein the set of partition modes includes at least one non-square partition.

11. The method of claim 10, wherein the set of partition modes includes: a first partition mode consisting of one partition with a size of 2N×2N; a second partition mode consisting of two partitions each with a size of 2N×N; a third partition mode consisting of two partitions each with a size of N×2N; a fourth partition mode consisting of four partitions each with a size of N×N; a fifth partition mode consisting of two partitions, the first partition having a size of 2N×(N/2) and the second partition having a size of 2N×(3N/2); a sixth partition mode consisting of two partitions, the first partition having a size of 2N×(3N/2) and the second partition having a size of 2N×(N/2); a seventh partition mode consisting of two partitions, the first partition having a size of (N/2)×2N and the second partition having a size of (3N/2)×2N; and an eighth partition mode consisting of two partitions, the first partition having a size of (3N/2)×2N and the second partition having a size of (N/2)×2N, and wherein a size of 2N×2N is equivalent to an entire coding unit, with the portion of the size before the ‘×’ symbol indicating the width of a partition and the portion of the size after the ‘×’ symbol indicating the height of a partition.

12. The method of claim 11, wherein the first partition mode indicates four transform unit partitions each with a size of N×N, the second partition mode indicates four transform unit partitions each with a size of 2N×(N/2), the third partition mode indicates four transform unit partitions each with a size of (N/2)×2N, the fourth partition mode indicates four transform unit partitions each with a size of N×N, the fifth partition mode indicates four transform unit partitions each with a size of 2N×(N/2), the sixth partition mode indicates four transform unit partitions each with a size of 2N×(N/2), the seventh partition mode indicates four transform unit partitions each with a size of (N/2)×2N, and the eighth third partition mode indicates four transform unit partitions each with a size of (N/2)×2N.

13. The method of claim 10, wherein the set of partition modes includes: a first partition mode consisting of one partition with a size of 2N×2N, a second partition mode consisting of two partitions each with a size of 2N×N, a third partition mode consisting of two partitions each with a size of N×2N, and a fourth partition mode consisting of four partitions each with a size of N×N, and wherein a size of 2N×2N is equivalent to an entire coding unit, with the portion of the size before the ‘×’ symbol indicating the width of a partition and the portion of the size after the ‘×’ symbol indicating the height of a partition.

14. The method of claim 13, wherein the first partition mode indicates four transform unit partitions each with a size of N×N, the second partition mode indicates four transform unit partitions each with a size of 2N×(N/2), the third partition mode indicates four transform unit partitions each with a size of (N/2)×2N, and the fourth partition mode indicates four transform unit partitions each with a size of N×N.

15. The method of claim 10, wherein the set of partition modes includes: a first partition mode consisting of one partition with a size of 2N×2N, a second partition mode consisting of two partitions each with a size of 2N×N, a third partition mode consisting of two partitions each with a size of N×2N, a fourth partition mode consisting of four partitions each with a size of N×N, a fifth partition mode consisting of four partitions each with a size of 2N×(N/2), and a sixth partition mode consisting of four partitions each with a size of (N/2)×2N, and wherein a size of 2N×2N is equivalent to an entire coding unit, with the portion of the size before the ‘×’ symbol indicating the width of a partition and the portion of the size after the ‘×’ symbol indicating the height of a partition.

16. The method of claim 15, wherein the first partition mode indicates four transform unit partitions each with a size of N×N, the second partition mode indicates four transform unit partitions each with a size of 2N×(N/2), the third partition mode indicates four transform unit partitions each with a size of (N/2)×2N, the fourth partition mode indicates four transform unit partitions each with a size of N×N, the fifth partition mode indicates four transform unit partitions each with a size of 2N×(N/2), and the sixth partition mode indicates four transform unit partitions each with a size of (N/2)×2N.

17. An apparatus comprising:
a processor configured to encode video using the same set of coding unit partition modes for both inter coding among blocks from different video pictures and intra coding among blocks within a video picture, wherein a size of a transform unit partition is implicitly indicated by a size of a coding unit partition; and
a transmitter coupled to the processor, wherein the transmitter is configured to transmit encoded video to another apparatus.

18. The apparatus of claim 17, wherein the set of partition modes includes at least one non-square partition.

19. The apparatus of claim 18, wherein the set of partition modes includes: a first partition mode consisting of one partition with a size of 2N×2N; a second partition mode consisting of two partitions each with a size of 2N×N; a third partition mode consisting of two partitions each with a size of N×2N; a fourth partition mode consisting of four partitions each with a size of N×N; a fifth partition mode consisting of two partitions, the first partition having a size of 2N×(N/2) and the second partition having a size of 2N×(3N/2); a sixth partition mode consisting of two partitions, the first partition having a size of 2N×(3N/2) and the second partition having a size of 2N×(N/2); a seventh partition mode consisting of two partitions, the first partition having a size of (N/2)×2N and the second partition having a size of (3N/2)×2N; and an eighth partition mode consisting of two partitions, the first partition having a size of (3N/2)×2N and the second partition having a size of (N/2)×2N, and wherein a size of 2N×2N is equivalent to an entire coding unit, with the portion of the size before the ‘×’ symbol indicating the width of a partition and the portion of the size after the ‘×’ symbol indicating the height of a partition.

20. The apparatus of claim 19, wherein the first partition mode indicates four transform unit partitions each with a size of N×N, the second partition mode indicates four transform unit partitions each with a size of 2N×(N/2), the third partition mode indicates four transform unit partitions each with a size of (N/2)×2N, the fourth partition mode indicates four transform unit partitions each with a size of N×N, the fifth partition mode indicates four transform unit partitions each with a size of 2N×(N/2), the sixth partition mode indicates four transform unit partitions each with a size of 2N×(N/2), the seventh partition mode indicates four transform unit partitions each with a size of (N/2)×2N, and the eighth third partition mode indicates four transform unit partitions each with a size of (N/2)×2N.

21. The apparatus of claim 18, wherein the set of partition modes includes: a first partition mode consisting of one partition with a size of 2N×2N, a second partition mode consisting of two partitions each with a size of 2N×N, a third partition mode consisting of two partitions each with a size of N×2N, and a fourth partition mode consisting of four partitions each with a size of N×N, and wherein a size of 2N×2N is equivalent to an entire coding unit, with the portion of the size before the ‘×’ symbol indicating the width of a partition and the portion of the size after the ‘×’ symbol indicating the height of a partition.

22. The apparatus of claim 21, wherein the first partition mode indicates four transform unit partitions each with a size of N×N, the second partition mode indicates four transform unit partitions each with a size of 2N×(N/2), the third partition mode indicates four transform unit partitions each with a size of (N/2)×2N, and the fourth partition mode indicates four transform unit partitions each with a size of N×N.

23. The apparatus of claim 18, wherein the set of partition modes includes: a first partition mode consisting of one partition with a size of 2N×2N, a second partition mode consisting of two partitions each with a size of 2N×N, a third partition mode consisting of two partitions each with a size of N×2N, a fourth partition mode consisting of four partitions each with a size of N×N, a fifth partition mode consisting of four partitions each with a size of 2N×(N/2), and a sixth partition mode consisting of four partitions each with a size of (N/2)×2N, and wherein a size of 2N×2N is equivalent to an entire coding unit, with the portion of the size before the ‘×’ symbol indicating the width of a partition and the portion of the size after the ‘×’ symbol indicating the height of a partition.

24. The apparatus of claim 23, wherein the first partition mode indicates four transform unit partitions each with a size of N×N, the second partition mode indicates four transform unit partitions each with a size of 2N×(N/2), the third partition mode indicates four transform unit partitions each with a size of (N/2)×2N, the fourth partition mode indicates four transform unit partitions each with a size of N×N, the fifth partition mode indicates four transform unit partitions each with a size of 2N×(N/2), and the sixth partition mode indicates four transform unit partitions each with a size of (N/2)×2N.

25. The apparatus of claim 18, wherein a prediction mode and a partition mode for a coding unit are signaled via a string of bits, wherein one of the bits in the string indicates whether or not the partition size for the coding unit is equivalent to the entire coding unit, another of the bits in the string indicates whether the coding unit partitions are horizontal strips or vertical strips, another of the bits in the string indicates, when the coding unit is partitioned into two partitions, whether or not the two partitions have the same size, another of the bits in the string indicates the position of a smaller partition if the coding unit is partitioned into two partitions of different sizes, and another of the bits in the string indicates, when the coding unit partitions are horizontal strips or vertical strips, whether or not the number of the partitions of the same size is two or four, and wherein, when a slice type of the coding unit is either predictive or bi-predictive, one of the bits in the string indicates whether the prediction type is intra or inter.
